(19) United States
(12) Patent Application Publication
(10) Pub. No.: US 2025/0050526 A1
(43) Pub. Date: Feb. 13, 2025

(54) System and method for separating food

(71) Applicants: Carla Jean Wood, Johnston, IA (US); Brandon James Wood, Urbandale, IA (US); Joel Thomas Jeanblanc, Grimes, IA (US)

(72) Inventors: Carla Jean Wood, Johnston, IA (US); Brandon James Wood, Urbandale, IA (US); Joel Thomas Jeanblanc, Grimes, IA (US)

(73) Assignee: CARBBAN ENTERPRISES L.L.C., West Des Molnes, IA (US)

(21) Appl. No.: 18/232,088

(22) Filed: Aug. 9, 2023

(51) Int. Cl. B26B 29/06; B26B 3/04

(52) U.S. Cl. CPC B26B 29/063; B26B 3/04

(57) ABSTRACT

The present disclosure is directed to an improved meat chopper and method for using the chopper to chop large portions of food on a cooking surface. The improved chopper allows a user to chop large portions of ground meat at a time and allows the user to access meat in the corners of the cooking surface. The size and weight of the chopper allows a user to quickly chop large portions of meat. The stainless steel construction of the chopper makes the chopper easy to clean and reduces damage to the chopper during use. The chopper has a handle coupled to a frame containing multiple blades to chop the meat. The increased size of the chopper and spacing between the blades prevents meat from becoming stuck between the blades during use. The rectangular frame containing the blades acts as a blade itself, increasing the amount of meat separated with each press of the chopper into the meat.

### TECHNICAL FIELD

The disclosed embodiments relate generally to a system and apparatus for separating food and, in particular, to the use of a device to quickly separate large portions of ground meat on a grill into smaller portions of meat to allow the meat to cook more quickly and evenly.

### BACKGROUND

The present invention relates to an improvement on the systems and methods for chopping meat, such as ground beef, on a grill. To allow the interior of large portions of meat to cook evenly on a grill, it is desirable to use a device to chop the meat into smaller portions. These smaller portions cook more evenly and quickly than large portions of meat. Additionally, some recipes, such as loose meat sandwiches, call for smaller portions of meat.

While it is known in the art to separate large portions of meat on a grill using a spatula or prior art meat chopper, such devices are typically too small and fragile to be used to quickly portion a large, partially frozen slab of ground beef into smaller amounts. It would therefore be desirable to provide an apparatus and method capable of efficiently portioning large portions of meat into smaller portions on a cooking surface.

Prior art, small, personal use “meat choppers” are typically made of a soft lightweight resilient material so they can be easily manipulated during use and cleaned between uses. They are often provided with a thin cylindrical handle with plastic fins radiating from the bottom of the handle to allow a user to grab and move the handle up and down to chop meat underneath. Such devices are desirable for use in small circular pans, such as those used for home cooking. Although such devices are useful for small applications, they are not sturdy enough or large enough for commercial applications. Moreover, the fins of such small devices are not scalable to larger commercial applications as the constant stress of chopping meat at a large distance from the handle would damage the fins. It would therefore be desirable to provide an apparatus and method for chopping large commercial amounts of meat on a cooking surface without damaging the apparatus.

The present invention uses an improved meat separator having a handle coupled to a frame that supports a plurality of chopping blades. By supporting the blades on the ends, the device allows for larger blades that can be used in commercial applications. In addition, the frame is provided with a right angle, allowing the frame to chop meat at the corners of a commercial cooking surface.

### SUMMARY OF THE DISCLOSED SUBJECT MATTER

The system and method of the present disclosure is directed to an improved meat chopper and method for chopping and separating large portions of meat into smaller portions. The method of use involves placing food, such as meat, onto a cooking surface and repeatedly pressing the improved meat chopper into the meat until the meat has been reduced to portions of a predetermined size. The rectangular shape of the chopper allows a user to access meat in the corners of the cooking surface. The chopper is constructed of stainless steel to make the chopper easy to clean and to reduce damage to the chopper during use. The chopper has a handle coupled to a frame containing multiple blades. The large size of the chopper and increased spacing between the blades prevents meat from becoming stuck between the blades during use. The rectangular frame containing the blades acts as a blade itself, further increasing the amount of meat separated with each press of the chopper into the meat.

Other implementations of an improved chopper are disclosed, including implementations directed to crossed blades and tapered blades.

### BRIEF DESCRIPTION OF THE DRAWINGS

The present invention will now be described, by way of example, with reference to the accompanying drawings in which:

FIG. 1 illustrates a top perspective view of the chopper positioned over a portion of meat on a cooking surface;

FIG. 2 illustrates a bottom perspective view of the chopper of FIG. 1;

FIG. 3 illustrates a side perspective view of the chopper of FIG. 1;

FIG. 4 illustrates a top perspective view of the weldments of the chopper of FIG. 1;

FIG. 5 illustrates a top elevation of the chopper of FIG. 1 being pressed into a portion of meat on a cooking surface; and

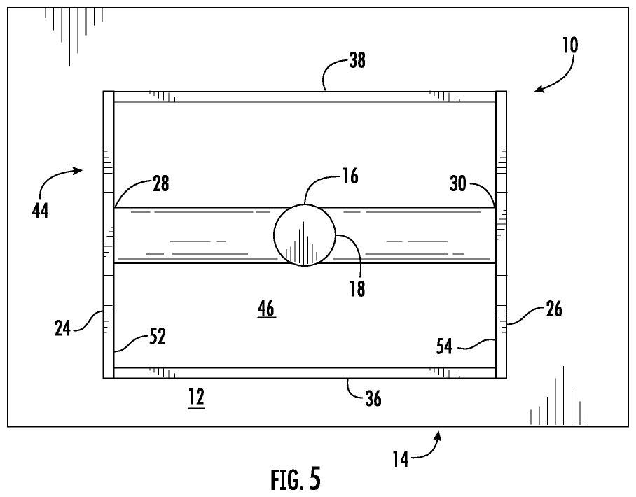

FIG. 6 illustrates a chopper in accordance with another embodiment.

### DESCRIPTION OF EMBODIMENTS

In general, the techniques of this disclosure may enable a user to chop a large portion of meat into smaller portions directly on a cooking surface. The large construction of the chopper and the spacing of the blades allows a user to quickly process a large portion of meat, while reducing the likelihood of meat getting stuck between the blades of the chopper.

To prevent meat from getting stuck in the corners of the cooking surface, the chopper has a frame with corners that allow a user to position the chopper into the corner of the cooking surface to process meat that has migrated there. The chopper is large and heavy to facilitate chopping large portions of meat and to chop meat that may partially frozen. The stainless steel construction of the chopper makes the chopper easier to clean, reduces damage to the chopper during use, makes the chopper heat resistant, and reduces the likelihood of bacterial contamination of the chopper between uses. The chopper is provided with three parallel blades, that work in conjunction with the frame of the chopper to chop meat without the meat becoming stuck between the blades or between the blades and the frame. Alternatively, the chopper may be provided with cross-hatched blades to chop the meat more with each stroke of the chopper.

### Exemplary Systems

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first image could be termed a second image, and, similarly, a second image could be termed a first image, without departing from the scope of the present invention. The first image and the second image are both images, but they are not the same image.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

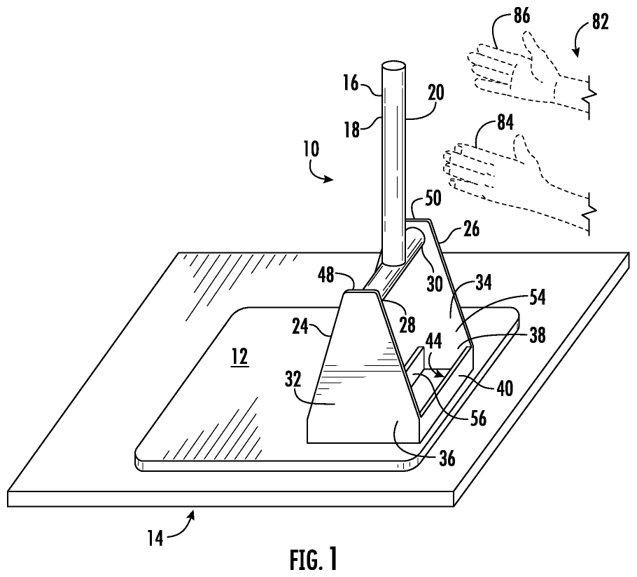

Attention is now directed toward embodiments of the system and method for efficiently separating large portions of food, such as meat, on a cooking surface into smaller portions of food to allow the food to cook quicker and more evenly. FIG. 1 is a top perspective view of chopper 10 positioned over a large portion of food, such as ground meat 12, located on a heated commercial grill 14. The ground meat 12 may be fresh, unfrozen, or partially frozen. The chopper 12 is constructed entirely of stainless steel. The chopper 12 has a handle 16 that is a cylinder of solid stainless steel 4 cm in diameter and 30 cm long. The handle 16 may be as little as 1 cm in diameter and as large as 7 cm or more in diameter and is preferably anywhere from 10 cm to 100 cm in length. The handle 16 may be of any desired length, but is preferably long enough to allow a user 82 to grasp the handle 16 with two hands 86 and 88. The handle 16 is provided with a grip 18, that may be cross-hatching 20, molded finger grooves, cut rings, or any other desired gripping surface. If desired, a grip of silicone or other material may be provided over the handle 16 to make the handle 16 easier to grip.

As shown in FIG. 1, a crossbar 22 is welded or otherwise secured to the handle 16. The crossbar 22 is a 15 cm long solid stainless steel cylinder of the same diameter as the handle 16. Alternatively, the handle 16 and/or the crossbar 22 may have a square cross-section or any desired cross-section. A pair of shoulders 24 and 26 are welded to the ends 28 and 30 of the crossbar 22. The bottoms 32 and 34 of the shoulders 24 and 26 are secured to 16.5 cm long end plates 36 and 38 which, in turn, are secured to 17.5 cm long side plates 40 and 42 to form a rectangular frame 44 defining an interior 46 having at least one 90-degree corner. The end plates 36 and 38 may be welded or otherwise secured to the bottoms 32 and 34 of the shoulders 24 and 26 in accordance with one or more aspects of the present disclosure. The end plates 36 and 38 are bladed portions of the chopper 10 used to chop the meat 12. Alternatively, as show in FIG. 1, the end plates 36 and 38 may be constructed integral with the bottoms 32 and 34 of the shoulders 24 and 26.

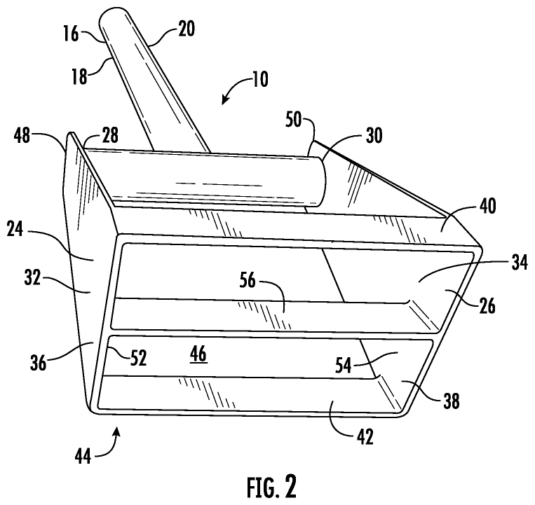

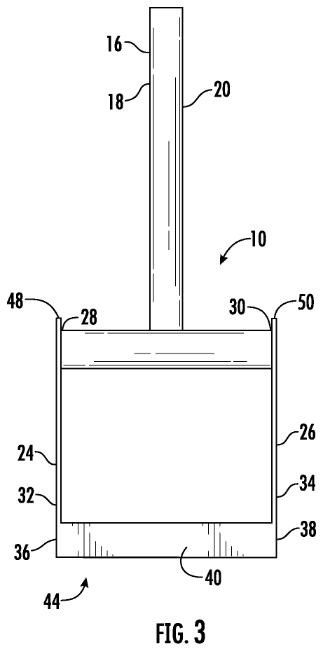

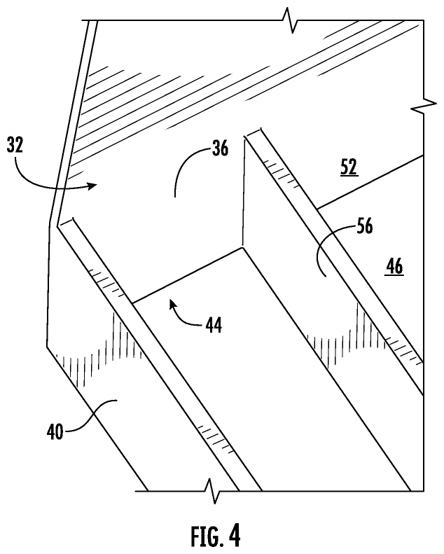

The shoulders 24 and 26 are constructed of solid pieces of 3 mm thick stainless steel. The shoulders 24 and 26 taper from the bottoms 32 and 34 of the shoulders 24 and 26, which are 18 cm long, to the tops 48 and 50 of the shoulder 24 and 26, which are 3 cm long. End plates 36 and 38 have interior walls 52 and 54. As shown in FIGS. 1-4, a stainless steel blade 56 is welded or otherwise secured to the interior walls 52 and 54 of the end plates 36 and 38. The blade 56 is 3 mm wide, 17.5 cm long, and 2.5 cm high. While the blade 56 may be constructed of any desired dimensions, it is preferably constructed with a width, or “cutting edge,” less than one fourth the height of the blade 56. The blade 56 is preferably welded at least 5 cm apart from the side plates 40 and 42, and most preferably about 8.3 cm from the side plates 40 and 42. The end plates 36 and 38, side plates 40 and 42, and blade 56 may be tapered toward any desired cutting edge. The chopper 12 is preferably greater than 40 cm in height and greater than 2 kg in weight, with a width of 17.8 cm and a width of 16.5 cm.

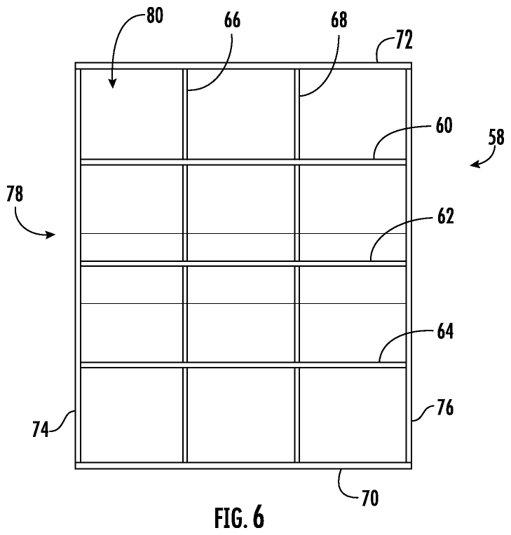

As shown in FIG. 6, in another embodiment of the present invention a chopper 58, may be provided with three blades 60, 62, and 64 in addition to two cross blades 66 and 68. The two cross blades 66 and 68 are welded to the three blades 60, 62, and 64, as well as to the two end plates 70 and 72. Likewise, the three blades 60, 62, and 64, are welded to the two side plates 74 and 76. To accommodate the additional blades, the frame 78 of the chopper 58 is larger to allow the open spaces 80 between the cross blades 66 and 68, blades 60, 62, and 64, two end plates 70 and 72, and two side plates 74 and 76 to be at least 5 cm×5 cm.

To use the chopper 12 of the present invention food, such as ground beef 12 is provided on the grill 14. Alternatively, foods, such as potatoes, yams, or dough may be used. Similarly, the food may be processed on a table, in a bowl, in a pan, or any other desired area. Once the ground beef 12 is provided on the grill 14, a user 82 grabs the chopper 10 by the handle 16 and raises the chopper 10 above the ground meat 12. The user 82 then brings the chopper 12 down into contact with the ground meat 12 with sufficient force to separate the ground meat 12 into smaller portions 84. If the effort is unsuccessful in separating the ground meat 12, because the ground meat is partially frozen and/or too thick, the user 12 continues chopping the ground meat 12 with the chopper 10 until the ground meat 12 has been reduced to the desired size of smaller portions 84. In addition to chopping the user 82 may use the chopper 10 to grind the ground meat 12 into smaller portions by simply pressing the chopper 10 into the ground meat rather than chopping it. It is desirable to push the chopper 10 into contact with the grill 14 to ensure complete separation of the ground meat 12. The chopper 10 may also be used to manipulate and churn the ground meat during the cooking process. The frame 44 of the chopper 10 is preferably rectangular to allow the user to reach into the corners 82 of the grill 14 to retrieve, chop, and manipulate meat that has migrated into the 90-degree corners 82 of the grill 14 in accordance with one or more aspects of the present disclosure.

Although the invention has been described with respect to a preferred embodiment thereof, it is to be understood that it is not to be so limited since changes and modifications can be made therein which are within the full, intended scope of this invention as defined by the appended claims.

What is claimed is:

1. A chopper comprising:
a handle;
a shoulder coupled to the handle;
a frame coupled to the shoulder, wherein the frame defines an interior and comprises;
a first bladed portion defining a first interior wall;
a second bladed portion defining a second interior wall;
a blade comprising:
a cutting surface;
a length;
a first end secured to the first interior wall; and
a second end secured to the second interior wall;
wherein the cutting surface of the blade is less than one fourth the height of the blade;
wherein the chopper weighs at least one kilogram.

2. The chopper of claim 1, wherein the length of the blade is at least ten centimeters.

3. The chopper of claim 2, wherein the blade has a height of at least one centimeter.

4. The chopper of claim 3, wherein the first bladed portion had a height of at least one centimeter.

5. The chopper of claim 4, wherein the second bladed portion had a height of at least one centimeter.

6. The chopper of claim 1, wherein the frame defines at least one 90-degree angle.

7. The chopper of claim 1, wherein the interior is rectangular.

8. The chopper of claim 1, wherein the first bladed portion is straight, the second bladed portion is straight and the first bladed portion and second bladed are coupled to one another at a 90-degree angle.

9. The chopper of claim 1, further comprising:
a supplemental blade comprising:
a supplemental cutting surface;
a supplemental length;
a third end secured to the first interior wall; and
a fourth end secured to the second interior wall;
wherein the cutting surface of the supplemental blade is less than one fourth the height of the supplemental blade.

10. The chopper of claim 9, further comprising:
a second supplemental blade comprising:
a second supplemental cutting surface;
a second supplemental length;
a fifth end secured to the first interior wall; and
a sixth end secured to the second interior wall;
wherein the cutting surface of the second supplemental blade is less than one fourth the height of the second supplemental blade.

11. A chopper comprising:
a handle;
a crossbar coupled to the handle;
a shoulder coupled to the crossbar;
a rectangular frame coupled to the shoulder, the rectangular frame defining an interior and comprising:
a first blade having a first interior face;
a second blade coupled to the first blade;
a third blade coupled to the second blade, the third blade having a second interior face;
a fourth blade coupled to the third blade and the first blade;
a fifth blade contained within the interior, wherein the fifth blade comprises:
a height;
a cutting surface;
a first end coupled to the first interior face; and
a second end coupled to the second interior face;
wherein the cutting surface of the fifth blade is less than one fourth the height of the blade;
wherein the chopper weighs at least one kilogram.

12. The chopper of claim 11, wherein the first blade, the second blade, the third blade, the fourth blade, and the fifth blade all define a tapered cutting surface.

13. The chopper of claim 11, wherein the handle has a top and wherein the distance between the top and the cutting surface of the fifth blade is at least 40 centimeters.

14. The chopper of claim 11, further comprising a supplemental shoulder coupled to the crossbar and to the rectangular frame.

15. The chopper of claim 11, wherein the first shoulder and the second shoulder taper from the rectangular frame to the crossbar.

16. The chopper of claim 11, wherein the handle and the crossbar are cylindrical.

17. A method for chopping food on a rectangular cooking surface comprising:
providing a food to be chopped on the rectangular cooking surface;
providing a chopper comprising:
a handle;
a shoulder coupled to the handle;
a frame coupled to the shoulder, wherein the frame defines a 90-degree corner and an interior, wherein the frame comprises;
a first bladed portion defining a first interior wall;
a second bladed portion defining a second interior wall;
a blade comprising:
a cutting surface;
a length;
a first end secured to the first interior wall; and
a second end secured to the second interior wall;
wherein the cutting surface of the blade is less than one fourth the height of the blade;
wherein the chopper weighs at least one kilogram and has at least one dimension at least 40 centimeters;
raising the chopper above the food;
repeatedly pushing the chopper into the food until the blade contacts the cooking surface in a manner that reduces the food into smaller portions;
wherein the cooking surface defines a 90-degree corner; and
using the 90-degree corner of the frame to move a portion of the food out of the 90-degree corner of the cooking surface.

18. The method of claim 17, wherein the chopper comprises:
a supplemental blade comprising:
a supplemental cutting surface;
a supplemental length;
a third end secured to the first interior wall; and
a fourth end secured to the second interior wall.

19. The method of claim 17, wherein the rectangular frame comprises a third bladed portion and a fourth bladed portion, wherein the first bladed portion is coupled to the second bladed portion, the second bladed portion is coupled to the third bladed portion, the third bladed portion is coupled to the fourth bladed portion, and the fourth bladed portion is coupled to the first bladed portion.

20. The method of claim 17, wherein the food is ground meat.
